(19) United States
(12) Patent Application Publication
(10) Pub. No.: US 2026/0277171 A1
(43) Pub. Date: Sep. 17, 2026

(54) MULTI-MODAL, MULTI-AGENTIC SYSTEM ASSOCIATED WITH A MANUFACTURING SYSTEM

(71) Applicant: Applied Materials, Inc., Santa Clara, CA (US)

(72) Inventors: Abhinav Kumar, Milpitas, CA (US); Brett Robert Schroeder, Portland, OR (US); Regina Germanie Freed, Los Altos, CA (US); Adrienne Melissa Martin Bergh, Los Gatos, CA (US); Hexuan Wang, Fremont, CA (US)

(21) Appl. No.: 19/080,453

(22) Filed: Mar. 14, 2025

(51) Int. Cl. G05B 13/02

(52) U.S. Cl. CPC G05B 13/027

(57) ABSTRACT

Methods and systems for performing tasks associated with a manufacturing system using a multi-modal, multi-agentic framework. A user query to perform a task pertaining to a manufacturing system including a set of specialized subsystems that are each associated with an aspect of a manufacturing process of the manufacturing system is detected from a client device. A set of operations associated with the task is determined. Each operation is associated with a distinct artificial intelligence (AI) model. For each operation in the set, an instruction to perform the operation is transmitted to a computing device associated with the respective distinct AI model corresponding to the instructed operation. Data corresponding to an output of the respective distinct AI model is received from each computing device, which is used to generate a response to the user query. The generated response is provided to the client device.

### TECHNICAL FIELD

Embodiments of the present disclosure relate, in general, to manufacturing systems and more particularly to systems and methods for a multi-modal, multi-agentic framework for tasks associated with a manufacturing system.

### BACKGROUND

Some tasks related to a manufacturing system can involve artificial intelligence (AI) models associated with specialized subsystems (e.g., systems within the manufacturing system associated with an aspect of a manufacturing process). However, subsystems may be unable to communicate and share information, e.g., as they may not share common memory and/or hardware components, such as manufacturing equipment, sensors, etc., which prevents AI models from easily accessing data stored or collected in a separate subsystem. As such, performing a task associated with a manufacturing system can involve running multiple AI models and transmitting data requests and responses between different subsystems, which uses significant computational power.

### SUMMARY

Some of the embodiments described cover a multi-modal, multi-agentic framework for performing tasks associated with a manufacturing system. The method includes detecting, from a client device, a user query to perform a task pertaining to a manufacturing system associated with a set of specialized subsystems, where each of the set of specialized subsystems is associated with an aspect of a manufacturing process of the manufacturing system. The method further includes determining a set of operations associated with the task of the user query. The set of operations are associated with a distinct artificial intelligence (AI) model. The method further includes transmitting, to each of a set of computing devices, an instruction to perform a respective operation of the set of operations associated with the task, where each of the set of computing devices is associated with a respective distinct AI model corresponding to an instructed respective operation and associated with a respective specialized subsystem of the set of specialized subsystems. The method further includes, responsive to transmitting, to each of the set of computing devices, the instruction to perform the respective operation, receiving, from each of the set of computing devices, data corresponding to an output of the respective distinct AI model based on the instructed respective operation. The method further includes generating a response to the user query based on the data received from each of the set of computing devices, where the response corresponds to the task pertaining to the manufacturing system. The method further includes providing the generated response to the user query to the client device in accordance with the user query.

In some implementations, the task includes at least one of a trend analysis task, a design of experiment (DOE) task, an experiment analysis task, or one or more software-based engineering operations.

In some implementations, determining a set of operations associated with the task of the user query further includes providing the user query as an input to an AI model, where the AI model is trained to predict one or more operations associated with tasks of a given user query associated with the manufacturing system, and obtaining one or more outputs of the AI model, where the one or more outputs include an indication of the set of operations.

In some implementations, the distinct AI model includes one of a knowledge query model, a coding model, a hardware control model, or an analysis model.

In some implementations, the instruction to perform the respective operation of the set of operations associated with the task is transmitted to an AI agent associated with the respective distinct AI model. The data corresponding to the outputs of the respective distinct AI model is received from the AI agent.

In some implementations, the method further includes identifying one or more of an external system or a database associated with the respective operation of the set of operations. The method further includes transmitting with the instruction to perform the respective operation, at least one of: an indication of the identified one or more of the external system or the database, or additional data associated with the respective operation retrieved from the identified one or more of the external system or the database.

In some implementations, the user query is a natural language query and each distinct AI model is a respective large language model (LLM) trained to perform the corresponding respective operation associated with a specialized subsystem of the manufacturing system.

In some implementations, the set of operations includes at least one of obtaining historical data, generating code, generating a design of experiment, executing instructions for hardware, or analyzing experiments.

In some implementations, the set of specialized subsystems includes at least one of inspection systems, yield analysis systems, data collection systems, data analytics and feedback systems, research and development systems, process characterization systems, or simulation and modeling systems.

In some implementations, the method further includes detecting, from the client device, an additional user query to perform an additional task based on the generated response, where the additional user query corresponds to the user query. The method further includes determining an additional set of operations associated with the additional task of the additional user query, where each of the additional set of operations are associated with an additional distinct AI model. The method further includes transmitting, to each of an additional set of computing devices, an additional instruction to perform an additional respective operation of the additional set of operations associated with the additional task, where each of the additional set of computing devices is associated with a respective additional distinct AI model corresponding to an additional instructed respective operation and associated with another respective specialized subsystem of the set of specialized subsystems. The method further includes responsive to transmitting, to each of the additional set of computing devices, the additional instruction to perform the additional respective operation, receiving, from each of the additional set of computing devices, additional data corresponding to an additional output of the respective additional distinct AI model based on the additional instructed respective operation. The method further includes generating an additional response to the additional user query based on the additional data received from each of the additional set of computing devices, where the generated additional response corresponds to an update in accordance with the additional user query and providing the generated additional response to the additional user query to the client device in accordance with the additional user query.

In some implementations, the method further includes obtaining historical data associated with at least one of one or more historical user queries or one or more historical generated responses to perform tasks pertaining to the manufacturing system and determining a set of routine user queries based on the obtained historical data, where the detected user query corresponds to a routine user query of the set of routine user queries.

In some implementations, the historical data further includes information pertaining to a time period during which at least one of the one or more historical user queries were received from at least one of the client device or another client device or the one or more historical generated responses were generated, and where each of the set of routine user queries corresponds to a respective time period. Detecting the user query to perform the task pertaining to the manufacturing system includes determining that a current time period corresponds to the time period associated with routine user query of the set of routine user queries.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts an illustrative system architecture, according to aspects of the present disclosure.

FIG. 2 is a block diagram of an example coordination agent, according to aspects of the present disclosure.

FIG. 3 is a flow chart of an example method for generating a response to a user query to perform a task associated with a manufacturing process, according to aspects of the present disclosure.

FIG. 4 is a block diagram of an example predictive system, according to aspects of the present disclosure.

FIG. 5 depicts a block diagram of an illustrative computer system operating in accordance with one or more aspects of the present disclosure.

### DETAILED DESCRIPTION

Implementations described herein provide systems and methods for a multi-modal, multi-agentic framework for tasks associated with a manufacturing system. A multi-modal, multi-agentic framework is a system that can process multiple types of input and output modalities (e.g., text, images, sensory data, voice etc.) and implements a set of agents each capable of performing specialized operations (e.g., generating code for a manufacturing process, performing knowledge queries, executing instructions for manufacturing equipment, identifying patterns in data, etc.) associated with a manufacturing process. As electronic device manufacturing is a quickly growing industry that involves highly precise and complex operations, small variations or errors in production (e.g., temperature changes, timing delays, etc.) runs can accumulate and yield significant losses, reduced performance, or higher costs (e.g., production costs to address substrate defects or meet manufacturing yield criteria). In light of this, complex process development tasks are performed to design, analyze, and/or refine new manufacturing processes or modify existing processes to improve production workflows and minimize variability. Process development tasks for a manufacturing process can include, for example, generating and/or modifying a design of experiment (DOE), running simulations and/or developing models reflecting real-world process engineering operations, analyzing (e.g., identifying trends or correlations in data to predict future behavior) historical data and/or experimental data associated with manufacturing processes to create and/or compile reports representing an outcome (or estimated or predicted outcome) of the manufacturing process, analysis and interpretation (e.g., determining whether data satisfies a criteria) of the reports, and so forth.

As seen above, manufacturing process development is a multi-task process, where each task can be divided into multiple operations, or individual actions performed as a part of completing the task. Operations can include obtaining historical data, generating code associated with a manufacturing process, generating a design of experiment, and analyzing (e.g., identifying trends in data and/or determining whether data satisfies one or more criterion) historical and/or experimental data. Each respective operation is performed (e.g., manually by a user, using software-based tools and resources, etc.). In some instances, analysis of each operation is performed manually by a user, meaning the analysis may change based on the engineering intuition and experience of the user.

In view of the above, some manufacturing systems utilize artificial intelligence (AI) models capable of performing one or more operations associated with a process development task, such as generating code for a manufacturing process or performing knowledge queries. In some instances, a system can utilize the AI model(s) to perform one or more operations associated with a process development task that would otherwise be performed manually by a user. For example, the system can utilize an AI model to perform an image analysis operation by providing an image of a substrate (e.g., captured before, during, or after a manufacturing process) as an input to an AI model trained to detect patterns on substrates and/or determine dimensions, features, and shapes of the detected patterns), where such image analysis operation would otherwise be performed manually (e.g., by a human). Conventionally, the above-described AI model(s) are trained to perform discrete operations, and, in some instances may be associated with different specialized subsystems (e.g., inspection systems, data collection systems, data analytics and feedback systems, simulation and modeling systems, etc.) within a manufacturing system.

An AI model associated with a particular subsystem may be unable to communicate and/or share information with another subsystem. For example, subsystems may not share memory (e.g., data stores) and/or hardware components (e.g., manufacturing equipment, sensors, etc.), which prevents an AI model in one subsystem from accessing data stored or collected (e.g., by sensors) in a separate subsystem. However, some AI models associated with a particular subsystem may rely on information generated by and/or stored in other subsystems. For example, an AI model that analyzes (e.g., identifies trends in data and/or determines whether data satisfies one or more criteria) the data from an experiment testing recipe files with different pressure settings may rely on data (e.g., information regarding the measurements of substrates and identified defects on substrates) regarding the substrates processed at each pressure setting, which is collected from a metrology station. As such, subsystems will transmit data requests to other subsystems to obtain information, which the other subsystems can transmit in response to the request. The transmission of data requests and responses can consume a significant amount of computing resources (e.g., network bandwidth, processing cycles, etc.), which are therefore unavailable to other processes.

Additionally, one subsystem may update output information based on information provided by another subsystem, which may involve running an AI model one or more additional times to update an output based on information provided by the other subsystem. Using the example above, the AI model that analyzes the data from an experiment testing recipe files is reliant on the data regarding the substrates processed at each pressure setting. As such, the analysis output by the AI model can change based on the amount of data provided by the metrology system. If the data for each substrate is transmitted as it is recorded, then the AI model may perform a new analysis each time data is received instead of performing the analysis once at the end after all the data is transmitted. The use of the AI model one or more additional times can also consume a significant amount of computing resources.

Aspects of the present disclosure address the above noted and other deficiencies by providing systems and methods for a multi-modal, multi-agentic framework for manufacturing process development tasks. A system can perform multiple operations associated with a process development task by managing multiple AI models and provide a comprehensive analysis of each operation based on a single user query to perform a process development task. The system can include one or more components that facilitate performance of operations associated with one or more process development tasks. Such components are referred to as a “coordination agent” herein. It should be noted that the term “agent” is used for the purpose of explanation and illustration only and is not intended to be limiting.

In some embodiments, a user query pertaining to a process development task (e.g., a trend analysis task, a DOE task, an experiment analysis, task, or one or more software-based engineering operations, etc.) associated with a manufacturing process can be detected. The user query can be provided by a user (e.g., via a client device) and/or can be detected based on historical query data associated with the multi-modal, multi-agentic framework. A user query can include a text prompt, one or more images (e.g., images depicting a processed substrate), a voice command, and/or sensory data (e.g., temperature, pressure, etc.) corresponding to a manufacturing system. Upon detection of the user query, a coordination agent can determine a set of operations associated with the task of the user query. The set of operations can include, for example, obtaining historical data associated with historical manufacturing processes (e.g., performed at the manufacturing system or another manufacturing system), generating code (e.g., code associated with one or more phases of the manufacturing process), generating a DOE associated with the manufacturing process, executing instructions for hardware (e.g., activating physical components of the manufacturing system in accordance with the process), or analyzing (e.g., identifying trends in data and/or determining whether data satisfies one or more criteria) experiments performed for the manufacturing process. In some embodiments, each operation can be associated with a specialized subsystem (e.g., inspection system, yield analysis system, data analytics and feedback system, simulation and modeling system, etc.) pertaining to a respective aspect or phase of the manufacturing process of the manufacturing system. In some embodiments, the coordination agent can determine the set of operations associated with the task by providing the user query and/or an indication of the task as an input to an AI model trained to determine operations associated with a respective process development task.

In some embodiments, one or more of the set of operations associated with the task can be associated with an AI model capable of performing the respective operation. Such AI models can include, for example, a knowledge query model, a code generation model, a hardware control model, or a trend analysis and correlation model (i.e., a model that identifies patterns in data to predict future behavior and/or determines the relationship between variables, such as temperature and pressure). The coordination agent can transmit an instruction, or a directive of how to perform an operation (e.g., providing process parameters and/or identifying data to be used in the operation), to perform an operation to a subsystem associated with the respective operation. Upon receiving an instruction from the coordination agent, a respective subsystem can obtain data associated with the instruction and provide the obtained data as an input to the respective AI model associated with the operation. The subsystem can obtain one or more outputs of the AI model, where the one or more outputs correspond to the respective operation corresponding to the received instruction. For example, a subsystem can be associated with DOE tasks and provide data to an AI model trained to generate a DOE for a manufacturing process based on given input data (e.g., historical data regarding process recipes). Another subsystem can be associated with defect detection and classification and the corresponding AI model can be trained to detect and classify a substrate defect based on a given image of a substrate.

In some embodiments, a subsystem can provide information or data pertaining to an operation performed by an AI model to another subsystem. For example, a first subsystem can obtain historical data from a knowledge query model and transmit the historical data to a second subsystem that provides the historical data to a trend analysis and correlation model trained to analyze trends (e.g., identify patterns and predict future behavior) based on the historical data. In some embodiments, the instruction sent to the first subsystem can include an instruction to transmit data to the second subsystem upon completion of the operation. In other embodiments, the first subsystem can transmit a notification to the coordination agent indicating completion of the operation, after which the coordination agent transmits an instruction to the first subsystem to transmit the data to a second subsystem. In other embodiments, upon receiving the operation completion notification, the coordination agent can retrieve the data from the first subsystem and transmit it to the second subsystem with an instruction to perform an operation using the data. In similar or other embodiments, the subsystems can access external systems or databases to perform an operation. For example, a subsystem that generates reports of metrology data can call an external application programming interface (API) to classify substrate defects (e.g., cracks or stains on the surface of a substrate) and use the classification data to create the report.

Each subsystem can transmit information or data associated with the operation to the coordination agent, which can generate a response to the user query based on the received information or data. For example, the coordination agent can summarize the data from each subsystem and generate a text response and/or graph summarizing the data. The coordination agent can provide the generated response to a client device in accordance with the request. In some embodiments, the coordination agent can determine whether additional information is to be obtained by the subsystems to generate the response to the user query and, if so, can transmit additional instructions to the subsystems to obtain such additional information.

Aspects of the present disclosure address deficiencies of the conventional technology by providing systems and methods for accelerating the performance of manufacturing process development tasks using a multi-modal, multi-agentic framework. As described herein, a system can utilize a set of AI models each capable of performing different operations associated with specialized subsystems of a manufacturing system. Accordingly, a single user query can prompt the system to perform a task that includes multiple operations, optimizing the workflow by consolidating the process of individually calling each subsystem and facilitating the transmission of data between subsystems. For example, a coordination agent can receive a request corresponding to a user query to perform a task and determine a set of operations associated with the task. The coordination agent can determine one or more subsystems associated with each operation in the set of operations and transmit an instruction to each subsystem to perform the respective operation. In some embodiments, the coordination agent can receive notifications from each subsystem regarding the status of an operation and facilitate the transfer of information between subsystems. Using the example regarding the trend analysis and correlation model that receives data regarding substrates processed at different pressures from a separate data-collecting subsystem, the coordination agent can receive a notification from the data-collecting subsystem indicating that the experiment has finished and all of the data has been collected. After receiving the notification, the coordination agent can retrieve the data from the data-collecting subsystem and transmit it with an instruction to identify trends in the data to the subsystem associated with the trend analysis and correlation model. In other embodiments, the coordination agent can transmit an instruction to the data-collecting subsystem that collected the data to directly transmit the data to the subsystem associated with the trend analysis and correlation model.

The facilitation of communication reduces the amount of data requests and corresponding responses transmitted between subsystems, reducing the amount of computing resources (e.g., processing cycles, memory space, network bandwidth, etc.) consumed by the system to perform the tasks described herein. Additionally, the facilitation of information can reduce the number of times an AI model is run to update an output based on information provided by another subsystem because the coordination agent can determine when an operation is complete and data can be transmitted to another subsystem for use in a separate operation. As such, AI models can run once using a complete data set instead of multiple times using incomplete data sets, reducing the computing resources used to run the model. In view of the above, embodiments of the present disclosure enable the system to manage and facilitate communication between specialized subsystems to perform a task requested by a user, which improves the overall efficiency of the system by reducing computing resources spent requesting and transmitting information between subsystems and running AI models one or more additional times to update outputs based on information received from a separate subsystem.

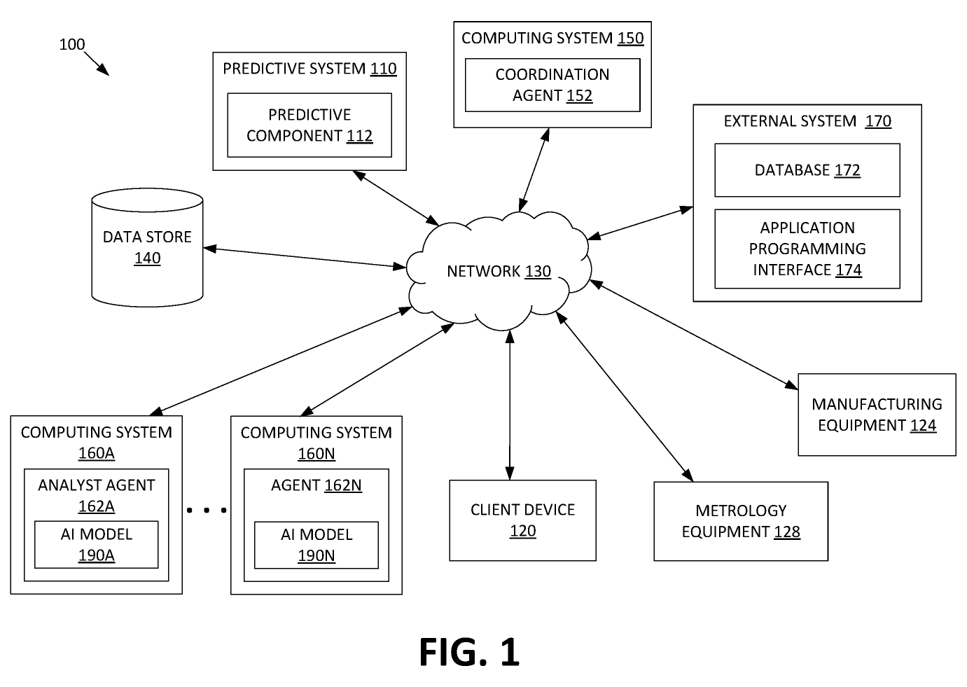

FIG. 1 depicts an illustrative system architecture 100, according to aspects of the present disclosure. System architecture 100 can include a client device 120, manufacturing equipment 124, metrology equipment 128, and/or a data store 140. In some embodiments, system architecture 100 can be included as part of or otherwise connected to a manufacturing system for processing substrates.

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit a film on a surface of the substrate, an etch process to form a pattern on the surface of the substrate, a polishing process to polish a material on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc. Substrates that are processed according to a process recipe (e.g., for manufacturing a portion of an electronic device, etc.) are referred to herein as production substrates.

Manufacturing equipment 124 can include one or more sensors that capture data for a substrate being processed at the manufacturing system. In some embodiments, the manufacturing equipment 124 and the sensors can be part of a sensor system that includes a sensor server (e.g., field service server (FSS) at a manufacturing facility) and sensor identifier reader (e.g., front opening unified pod (FOUP) radio frequency identification (RFID) reader for sensor system). Sensor data may include a value of one or more of temperature (e.g., heater temperature), spacing (SP), pressure, high frequency radio frequency (HFRF), RF bias, voltage of electrostatic chuck (ESC), electrical current, flow, power, voltage, etc. Sensor data may be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each substrate. In some embodiments, sensor data can include trace data collected during performance of one or more processes (e.g., substrate processes, maintenance processes, etc.) at manufacturing equipment 124. Trace data refers to data that indicates how components in a process chamber are operating and/or a state of an environment within a process chamber before, during, or after performance of an operation.

Metrology equipment 128 provides metrology data associated with substrates (e.g., production substrates, seasoning substrates, etc.) processed by manufacturing equipment 124. The metrology data can include a value of one or more of film property data (e.g., wafer spatial film properties), dimensions (e.g., thickness, height, etc.), dielectric constant, dopant concentration, density, defects, etc. In some embodiments, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology equipment 128 can be configured to generate metrology data associated with a substrate before or after a substrate process and/or a maintenance process. In some embodiments, metrology equipment 128 can be part of a metrology system that includes a metrology server (e.g., a metrology database, metrology folders, etc.) and metrology identifier reader (e.g., FOUP RFID reader for metrology system).

Metrology equipment 128 can be integrated with a station of the process tool of manufacturing equipment 124. In some embodiments, metrology equipment 128 can be coupled to or be a part of a station of the process tool that is maintained under a vacuum environment (e.g., a process chamber, a transfer chamber, etc.). Such metrology equipment 128 is referred to as integrated metrology equipment. Accordingly, the substrate can be measured by the integrated metrology equipment while the substrate is in the vacuum environment. For example, after a process (e.g., an etch process, a deposition process, etc.) is performed for the substrate, the metrology data for the substrate can be generated by the integrated metrology equipment without the processed substrate being removed from the vacuum environment. In other or similar embodiments, metrology equipment 128 can be coupled to or be a part of the process tool station that is not maintained under a vacuum environment (e.g., a factory interface module, etc.). Such metrology equipment is referred to as inline metrology equipment. Accordingly, the substrate is measured by the inline metrology equipment outside of the vacuum environment.

In additional or alternative embodiments, metrology equipment 128 can include metrology measurement devices that are separate (i.e., external) from manufacturing equipment 124. For example, metrology equipment 128 can be standalone equipment that is not coupled to any station of manufacturing equipment 124. For a measurement to be obtained for a substrate using external metrology equipment, a user of a manufacturing system (e.g., an engineer, an operator) can cause a substrate processed at manufacturing equipment 124 to be removed from manufacturing equipment 124 and transferred to metrology equipment 128 for measurement. In some embodiments, metrology equipment 128 can transfer metrology data generated for the substrate to the client device 120 coupled to metrology equipment 128 via network 130 (e.g., for presentation to a manufacturing user, such as an operator or an engineer). In other or similar embodiments, the manufacturing system user can obtain metrology data for the substrate from metrology equipment 128 and can provide the metrology data to computer system architecture via a graphical user interface (GUI) of client device 120.

The client device 120 may include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some embodiments, the metrology data may be received from the client device 120. In some embodiments, client device 120 displays a graphical user interface (GUI), where the GUI enables the user to provide, as input, metrology measurement values for substrates processed at the manufacturing system. In other or similar embodiments, client device 120 can display another GUI that enables the user to provide, as input, an indication of a type of substrate to be processed at the manufacturing system, a type of process to be performed for the substrate, and/or a type of equipment at the manufacturing system. In yet other or similar embodiments, client device 120 can display another GUI that presents sensor data collected by the sensors before, during, or after performance of a process (e.g., a substrate process, a maintenance process, etc.). It should be noted that one or more GUIs of client device 120 can provide and/or receive any data described herein.

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at manufacturing equipment 124. For example, data store 140 can store data collected by the sensors at manufacturing equipment 124 before, during, or after a substrate process (referred to as process data). Process data can refer to historical process data (e.g., process data generated for a previous substrate processed at the manufacturing system) and/or current process data (e.g., process data generated for a current substrate processed at the manufacturing system). Current process data can be data for which predictive data is generated. In some embodiments, data store can store metrology data including historical metrology data (e.g., metrology measurement values for a prior substrate processed at the manufacturing system). The data store 140 can also store contextual data associated with one or more substrates processed at the manufacturing system. Contextual data can include a recipe name, recipe operation number, preventive maintenance indicator, operator, etc. In some embodiments, contextual data can also include an indication of a difference between two or more process recipes or process operations. In some embodiments, data store 140 can additionally or alternatively store image data collected for a substrate before, during, or after processing of the substrate.

In some embodiments, data store 140 can be configured to store data that is not accessible to a user of the manufacturing system. For example, process data, spectral data, non-spectral data, and/or positional data obtained for a substrate being processed at the manufacturing system may not be accessible to a user of the manufacturing system. In some embodiments, all data stored at data store 140 is inaccessible by a user (e.g., an operator) of the manufacturing system. In other or similar embodiments, a portion of data stored at data store 140 is inaccessible by the user while another portion of data stored at data store 140 is accessible by the user. In some embodiments, one or more portions of data stored at data store 140 are encrypted using an encryption mechanism that is unknown to the user (e.g., data is encrypted using a private encryption key). In other or similar embodiments, data store 140 includes multiple data stores where data that is inaccessible to the user is stored in one or more first data stores and data that is accessible to the user is stored in one or more second data stores.

Computing system 150 can include a coordination agent 152 that coordinates or otherwise facilitates the generation of a response to a user query to perform a task pertaining to a manufacturing system. A task refers to an activity that involves the performance of a set of one or more operations. An operation refers to an action performed as a part of completing a task. For example, a task can be to create a graph that compares the average critical dimension uniformity (i.e., the uniformity of the smallest features or lines that can be reproduced on substrates during fabrication through etching or photolithography) of substrates from a specific metrology job to substrates from previous metrology jobs. Operations to complete the task can include identifying the metrology job that was submitted, measuring the images of the substrates from the metrology job, calculating the average critical dimension uniformity of the metrology job, identifying historical data associated with the average critical dimension uniformity for previous metrology jobs, and graphing the calculated average critical dimension uniformity and the historical data.

A specialized subsystem refers to a set of one or more components (e.g., servers, computing devices, manufacturing equipment, metrology equipment, etc.) within a manufacturing system that work together to perform one or more functions (e.g., substrate inspection, data collection, etc.) associated with an aspect of a manufacturing process. Example specialized subsystems can include inspection systems (e.g., to measure the dimensions of substrates and identify defects), yield analysis subsystems (e.g., to monitor the number of substrates that satisfy manufacturing criteria and identify causes of decreases in yield), data collection subsystems (e.g., to collect historical data from past substrate processes), data analytics and feedback subsystems (e.g., to monitor real-time data, such as sensor data and in-line measurements of substrates, identify trends in the data, and determine whether the data satisfies processing criteria), research and development subsystems (e.g., to test new substrate materials, processing materials, such as chemical solvents, and equipment), process characterization subsystems (e.g., to generate designs of experiments and determine acceptable ranges for and correlations between process parameters, such as temperature and pressure, and update and/or suggest process parameters for process recipes), simulation and modeling subsystems (e.g., to simulate the behavior of substrate materials, manufacturing tools, and processes to predict an outcome of a manufacturing process), and so forth.

In some embodiments, each specialized subsystem can include or otherwise have access to a computing system 160A-N (collectively and individually referred to as a computing system 160), an agent 162A-N (collectively and individually referred to as an agent 162), and one or more artificial intelligence (AI) models 190A-N (collectively referred to as AI model(s) 190). An agent 162 can refer to a software component, a hardware component, a firmware component, etc. that receives instructions (e.g., from coordination agent 152) to perform an operation, provides an input (e.g., an instruction) to an AI model 190 to perform the operation, and transmits the output to the coordination agent 152 or a separate subsystem. An instruction is a directive that defines how to perform an operation, such as providing parameters (e.g., temperature settings) and/or identifying data (e.g., historical data, process recipes, etc.) to be used when performing the operation. In some embodiments, specialized subsystems can reside on separate computing systems 160 (e.g., server machines). In other embodiments, specialized subsystems can reside on the same computing system 160 (e.g., server machines) as other subsystems and/or the coordination agent 152.

The coordination agent 152 can detect a user query to perform a task associated with a manufacturing system including multiple specialized subsystems. In some embodiments, the coordination agent 152 can receive the user query from a client device 120 (e.g., in response to a user interaction with a user interface (UI) of client device 120). In other or similar embodiments, the coordination agent 152 may detect the user query based on historical data associated with one or more historical user queries and/or one or more historical responses to perform tasks pertaining to the manufacturing system, as described herein. Upon detecting the user query, the coordination agent 152 can determine a set of operations to perform to complete the task and identify subsystems that can perform each operation and transmit an instruction to each identified subsystem to perform the respective operation. The coordination agent 152 can receive data (e.g., retrieved historical data, defect classifications, simulation data, identified patterns in submitted data, etc.) corresponding to the performed operation from each subsystem. In some embodiments, the data can correspond to an output of an AI model 190 that performed the operation. In some embodiments, the coordination agent 152 can coordinate between subsystems by transmitting data received from one subsystem to another subsystem to be used in an operation or transmitting an instruction to one subsystem to transmit data to another subsystem. The coordination agent 152 can generate a response to the user query based on the data received from each subsystem (e.g., by summarizing the received data) and provide the generated response to the client device 120, as described herein.

In some embodiments, the coordination agent 152 can receive user feedback (e.g., a user request including new tasks based on the generated response) from the client device 120 and update the generated response based on the feedback. For example, the feedback can include modifying a temperature parameter in a generated DOE. The coordination agent 152 can update the generated DOE (e.g., by transmitting instructions to subsystems with updated instructions that include the new temperature parameter and receiving the updated data) and transmit the updated DOE to the client device 120. The feedback process can be performed multiple times to update generated responses. In other or similar embodiments, the coordination agent 152 can update a generated query response based on data obtained from manufacturing equipment 124, metrology equipment 128, etc. (e.g., without user input via client device 120).

The system 100 can also include an external system 170, which can include a database 172 and/or an application programming interface (API) 174, in some embodiments. In some embodiments, the agents 162 can access the external database 172 to retrieve data (e.g., trend data, process recipes, etc.) and/or access an API 174 to perform an operation. For example, if system 100 lacks a defect classification model, an agent 162 with an instruction to perform a defect classification operation can access an API 174 to request a classification from an external application.

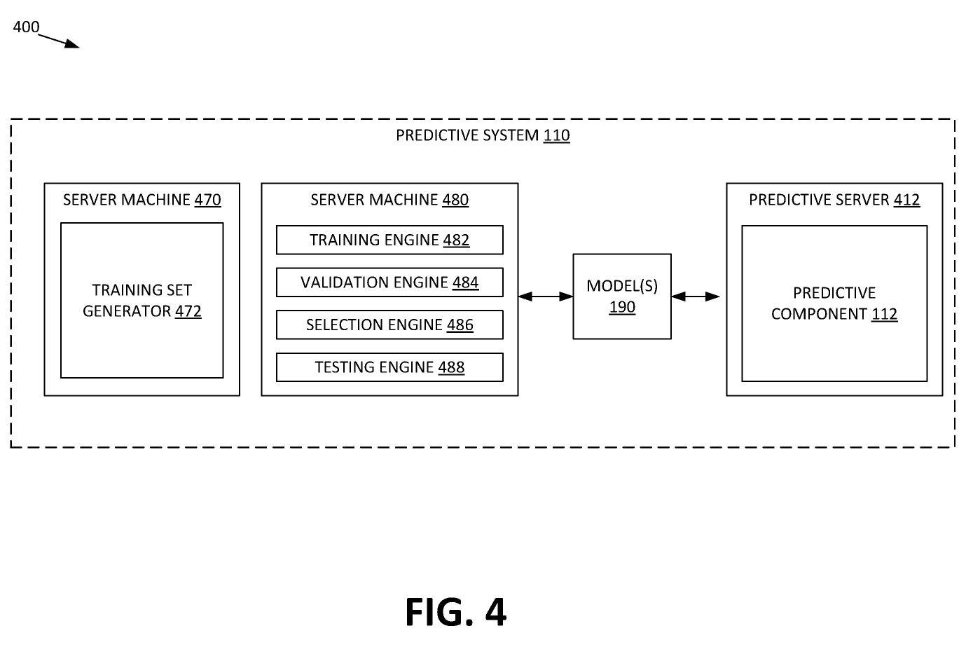

The system 100 can include a predictive system 110 with a predictive component 112 to assist the coordination agent 152 and agents 162. For example, in some embodiments, the predictive component 112 can provide a prompt associated with the user query (e.g., a summarization of a user query, such as a list of tasks corresponding to the user query) to an AI model trained to generate a set of operations for one or more tasks in the prompt. In some embodiments, the predictive component 112 can provide an input (e.g., an instruction to perform an operation and/or data from a subsystem) from an agent 162 to an associated AI model 190 to perform an operation. In some embodiments, the predictive component 112 can determine whether an output of an AI model 190 satisfies one or more criteria before providing the output to the agent 162. For example, the predictive component 112 can determine whether a defect classification for a defect on the surface of a substrate output by a defect classification model satisfies a confidence criteria before providing the classification to the associated agent. In other or similar embodiments, the predictive component 112 can train AI models 190 to perform operations. For example, the predictive component can train a defect classification model to classify defects by providing images of defects as training inputs and defect classifications for each image as a training output for each respective image. Further details regarding predictive system 110 are described in detail below with respect to FIG. 4.

As illustrated by FIG. 1, the client device 120, manufacturing equipment 124, metrology equipment 128, and data store 140 can be coupled to each other via a network 130. In some embodiments, network 130 is a public network that provides client device 120 with access to external system 170, data store 140, and other publicly available computing devices. In some embodiments, network 130 is a private network that provides client device 120 access to manufacturing equipment 124, metrology equipment 128, data store 140, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

In embodiments, a “user” can be represented as a single individual. However, other embodiments of the disclosure encompass a “user” being an entity controlled by one or more users and/or an automated source. For example, a set of individual users federated as a group of administrators can be considered a “user.”

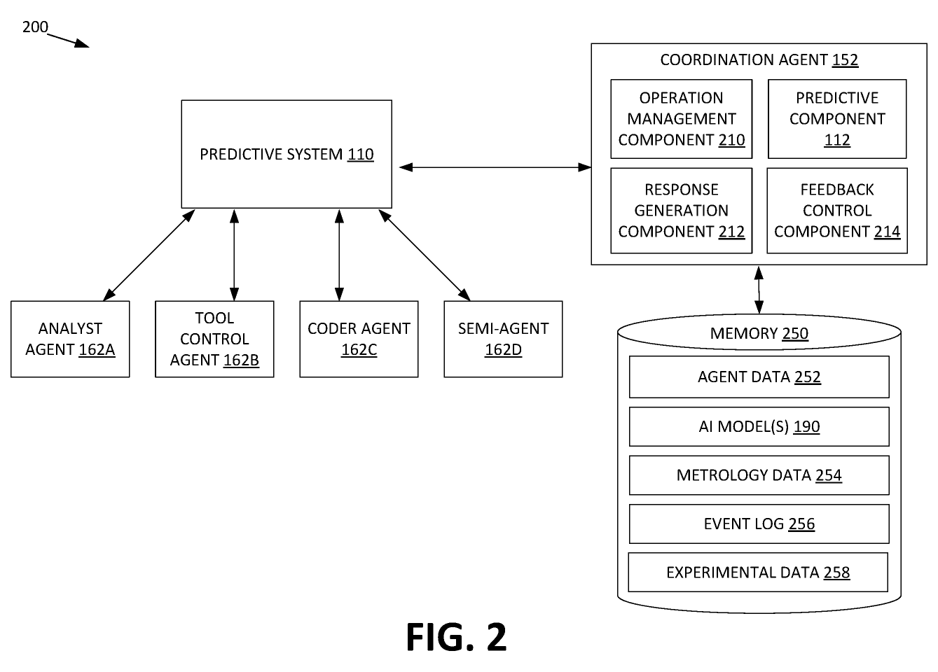

FIG. 2 is a block diagram of an example coordination agent 152, according to aspects of the present disclosure. As described above, the coordination agent 152 coordinates or otherwise facilitates the generation of a response to user query to perform a task associated with a manufacturing system associated with multiple specialized subsystems. In some embodiments, the coordination agent 152 can update a generated response based on feedback (e.g., an additional user query based on the generated response) received from a client device 120 and/or based on data received from manufacturing equipment 124, metrology equipment 128, etc. As illustrated by FIG. 2, coordination agent 152 can include an operation management component 210, a predictive component 112, a response generation component 212, and a feedback control component 214. In some embodiments, coordination agent 152 can be connected to the predictive system 110 and/or memory 250 (e.g., via network 130, via a bus). In other or similar embodiments, memory 250 can include any memory of or accessible to a component of system 100. For example, memory 250 can include, or be included in, data store 140, a memory of a client device 120, and so forth.

The predictive system 110 can be connected (e.g., via network 130) to one or more agents associated with different subsystems, in some embodiments. FIG. 2 depicts four types of agents that can be included in system 100, in some embodiments. The analyst agent 162A is an agent that is associated with an AI model trained to identify trends in data and predict future behavior and/or determine whether data satisfies one or more criteria. In some embodiments, the analyst agent 162A can identify relationships (e.g., a correlation where changes in one variable cause changes in another variable) between process parameters (e.g., temperature, pressure, etc.) and/or process outcomes (e.g., a type and/or amount of defects, a substrate measurement, etc.) to determine a cause of a process outcome (e.g., determine that a change in substrate film thickness is due to a change in pressure). The tool control agent 162B is an agent associated with an AI model trained to control hardware components (e.g., metrology equipment and/or manufacturing equipment). For example, a tool control agent 162B can receive recipe files with different pressures and provide it as input to the AI model, that controls manufacturing equipment to perform each process recipe and collect data (e.g., substrate dimension measurements, images of processed substrates) from each process. The coder agent 162C is associated with an AI model trained to generate code associated with one or more phases of a manufacturing process (e.g., code to generate mask designs for lithography, code to perform defect clustering to identify and analyze defects, etc.). In some embodiments, the AI model can support multiple programming languages. The semi-agent 162D can be associated with an AI model trained to make knowledge queries and retrieve requested information (e.g., historical data, manufacturing and/or troubleshooting guidelines, historical process recipes) from an internal and/or external system and/or database. For example, in some embodiments, the semi-agent 162D can determine one or more process parameters for a partial process recipe input by a user based on the historical process recipes. It should be noted that agents 162A-162D are provided for purposes of example and illustration only, and embodiments of the present disclosure can be applied to any type of agent associated with any type of AI model that is trained to perform tasks or operations pertaining to a manufacturing system, as described herein.

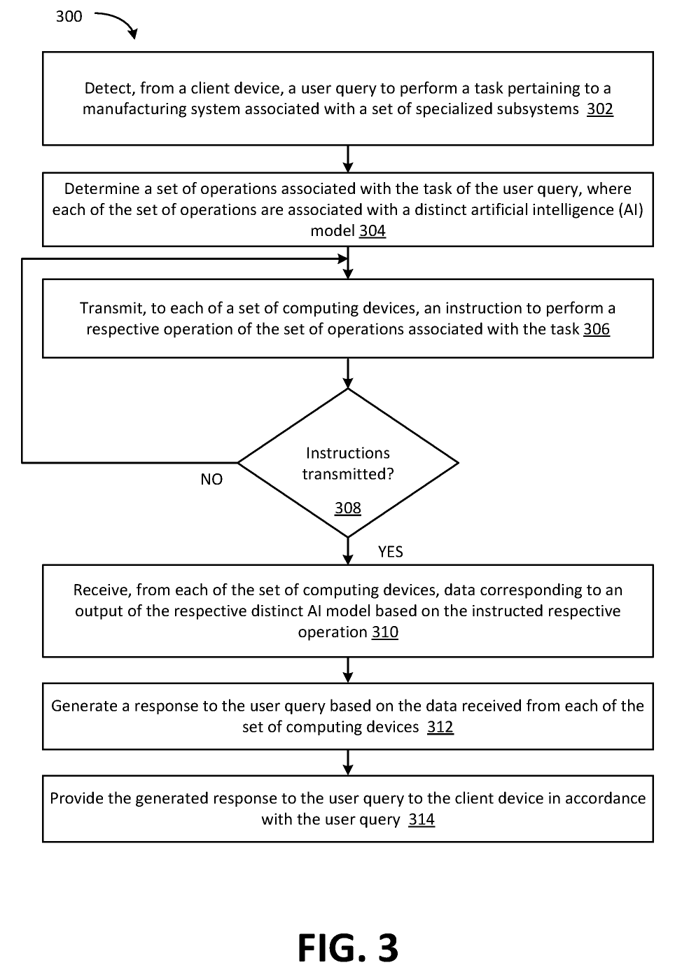

As described herein, coordination agent 152 can generate a response to a user query to perform a task associated with a manufacturing system associated with multiple specialized subsystems. In some embodiments, the subsystems can be associated with agents 162 and AI models 190 to perform operations corresponding to a task. The models 190 may be trained based on historical data associated with system 100 (or another system) to perform a respective operation. Details regarding generating the response to a user request to perform a task are provided herein with respect to FIG. 3.

FIG. 3 is a flow chart of an example method 300 for generating a response to a user query to perform a task associated with a manufacturing system associated with multiple specialized subsystems, according to aspects of the present disclosure. Method 300 is performed by processing logic that can include hardware (circuitry, dedicated logic, etc.), software (such as is run on a general-purpose computer system or a dedicated machine), firmware, or some combination thereof. In one implementation, method 300 can be performed by a computer system, such as computer system architecture 100 of FIG. 1. In other or similar implementations, one or more operations of method 300 can be performed by one or more other machines not depicted in the figures. In some aspects, one or more operations of method 300 can be performed by coordination agent 152.

For simplicity of explanation, method 300 is depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 302, processing logic detects a user query to perform a task associated with a manufacturing system associated with a set of specialized subsystems. In some embodiments, the user query can correspond to or otherwise include a textual input and/or a voice command provided by a user via client device 120 and/or a peripheral device of or connected to client device 120. In other embodiments, the coordination agent 152 can detect the user query and generate a prompt (e.g., a summarization of the user query) corresponding to the user query. For example, in some embodiments, the prompt can be a list of one or more tasks (e.g., generated by an AI model) corresponding to a user query. In some embodiments, the user query can be a natural language query. In some embodiments, a user query can include more than one task. Tasks can include trend analysis tasks associated with a current and/or historical manufacturing process (e.g., performed at the manufacturing system or another manufacturing system), DOE tasks associated with a manufacturing process (e.g., recommending and/or updating a DOE based on a historical DOE and/or historical data from a previous experiment), an experiment analysis task associated with a manufacturing process (e.g., identifying whether data from an experiment testing a new process recipe satisfies one or more criteria, identifying one or more process parameters that optimize hardware design, such as improving yield or reducing power consumption, based on the experimental data), and/or one or more software-based engineering operations associated with a manufacturing process (e.g., running a simulation, generating and testing code for hardware-software integration in manufacturing and/or metrology equipment, etc.).

In some embodiments, the coordination agent 152 can initiate a user query without user interaction or input. As queries are received and/or responses are generated, the coordination agent 152 can store data (e.g., in memory 250 and/or data store 140) associated with each query and/or response to such queries as historical data, in some embodiments. Depending on the embodiment, the historical data can indicate a time period and/or a context of system 100 when the query was received and/or the response was generated. The coordination agent 152 can generate a list of routine tasks to be performed based on the historical data, and, once the coordination agent 152 detects that the current time period reflects a time period for a routine task and/or the context of the system matches (or approximately matches) the condition of the system when a query/response was obtained, the coordination agent 152 can detect that a user query corresponding to the routine task should be obtained. For example, the coordination agent 152 can maintain a history of queries (e.g., stored in memory 250 and/or data store 140) and identify a recurring query to determine defect measurement data for a process that is performed at the same time once a week. As such, when the coordination agent 152 detects that the current time is the same time as when the recurring query is routinely received, the coordination agent 152 can initiate the recurring query without user interaction or input.

In some embodiments, the coordination agent 152 can generate one or more suggested queries before receiving a user query. The generated suggested queries can be based on a learned environment (e.g., determined patterns based on previously received user queries). Using the example above, the coordination agent 152 can maintain a history of queries (e.g., stored in memory 250 and/or data store 140) and identify a recurring query to determine defect measurement data for a process that is performed weekly. As such, when the coordination agent 152 detects that the time is the same as when the recurring query is received, the coordination agent 152 can generate a suggested query to determine defect measurement data for the process that was performed that week, which is displayed via a user interface (UI) on the client device 120. The UI can contain one or more UI elements (e.g., checkboxes, buttons, switches, etc.) that each pertain to a suggested task. Upon detection of a user selection of a respective UI element (e.g., marking the checkbox or pressing the button) pertaining to a suggested task, the coordination agent 152 can proceed to block 304 using the suggested task. In some embodiments, the coordination agent can modify a suggested query based on a user selection of a UI element (e.g., a checkbox) and/or a user query that modifies the suggested query. For example, a suggested query can be “what are the number of recipes run on Monday.” In some embodiments, the query may be displayed with one or more checkboxes that can be selected to narrow the query, such as listing temperature parameters and/or substrate materials (e.g., silicon), so the modified query will search for the number of recipes run on Monday that used a specific temperature and/or included specific substrate materials. In other embodiments, the coordination agent can receive a user query (e.g., a textual input or voice command) that modifies the suggested query. For example, the coordination agent 152 can receive a user query that requests the number of recipes run on Monday that include silicon as a substrate material based on the original suggested query of the number of recipes run on Monday.

In some embodiments, the coordination agent 152 can generate tasks based on a history of user queries associated with a user account. The user queries associated with a user account can be stored in memory 250 and/or data store 140. The coordination agent 152 can determine if the user account associated with the client device 120 has a query history (e.g., by checking the data store for queries associated with the user account) and generate a task based on a previous query. For example, a user query associated with a user account can include a request to generate a list of all process recipes beyond a desirable threshold (e.g., a production threshold of processed substrates that satisfy manufacturing criteria). When the coordination agent 152 detects the user account accessing client device 120, the coordination agent can generate a task and notify associated subsystems to update the list of process recipes beyond a desirable threshold to provide to the client device 120. In some embodiments, the UI on the client device can include UI elements (e.g., buttons, checkboxes) corresponding to tasks that can be performed when the coordination agent 152 detects a specific user account. Upon a user selection of the UI element corresponding to a task, the coordination agent 152 can store user preference data associated with a user account in memory 250 and/or data store 140 and perform certain tasks corresponding to the user preference data upon detecting the user account. For example, user preference data associated with an account can include performing a task to generate a report of the yield of a specific process performed that day. Thus, upon detecting the respective user account, the coordination agent 152 can notify the corresponding subsystems to perform an operation associated with the task of generating a report of the yield of a specific process performed on that day.

At block 304, processing logic determines a set of operations associated with the task corresponding to the user query (e.g., operations that will assist in performing the task). For example, a task to run a simulation with specific process parameters, can include an operation to generate the code to simulate the manufacturing environment. In some embodiments, the operation management component 210 included in the coordination agent 152 can determine the set of operations to perform to complete the task. In other embodiments, the predictive component 112 can provide the prompt associated with the user query as input to an AI model (e.g., model 190) trained to predict one or more operations associated with one or more tasks in the prompt. The predictive component 112 can receive the outputs of the AI model, which include an indication of a set of operations to perform. Operations can include obtaining historical data, generating code (e.g., code associated with one or more phases of the manufacturing process), generating a DOE associated with a manufacturing process, executing instructions for hardware equipment (e.g., activating a physical component of the manufacturing system in accordance with a manufacturing process), and/or analyzing experiments performed for a manufacturing process (e.g., identifying trends in data, determining whether data satisfies one or more criteria, etc.). Each set of operations are associated with a distinct AI model (e.g., model 190), which are each associated with a subsystem. In some embodiments, one or more of AI models 190 can be large language models (LLMs) trained to perform a specific operation.

At block 306, processing logic transmits, to each of a set of computing devices (e.g., computing system 160), an instruction to perform a respective operation of the set of operations associated with the task. Each computing device can be associated with a specialized subsystem, in some embodiments. As described above, each computing device can be associated with an AI model (e.g., model 190) trained to perform an operation associated with a respective subsystem. In some embodiments, the computing device can include an agent (e.g., agent 162) to provide an input (e.g., an instruction, parameters, data, etc.) to the AI model and obtain the one or more outputs. In some embodiments, the agent can retrieve data from an internal memory to provide as an additional input to an AI model 190. For example, an instruction can include an operation to modify an existing DOE to update a process parameter. The agent 162 can retrieve the identified DOE from an internal memory of the subsystem (e.g., computing system 160) and provide it as an input to the AI model 190. In other embodiments, the agent 162 can provide the instruction to the AI model 190 without additional data.

In some embodiments, the operation management component 210 can determine which computing devices to transmit an operation to using agent data 252, which includes information on the operations each subsystem performs. For example, to perform an operation to retrieve historical metrology data 254 from memory 250, the operation management component 210 can use agent data 252 to determine that a semi-agent 162D can retrieve historical data. The operation management component 210 can transmit an instruction to retrieve particular historical metrology data, and the semi-agent 162D can provide the instruction and/or the specified historical metrology data to a knowledge query model, which can retrieve the data.

In some embodiments, a subsystem (e.g., computing system 160) can provide information and/or data pertaining to an operation performed by an AI model to a separate subsystem. For example, a semi-agent 162D can receive an instruction to retrieve historical experimental data 258 pertaining to experiments determining pressure parameters for processing a substrate using a particular process recipe. The semi-agent 162D can call a knowledge query model retrieve the specified data (e.g., from memory 250) and provide it to analyst agent 162A (e.g., an agent that determines whether data satisfies one or more criteria), which receives an instruction to identify the pressure values that satisfy one or more criteria (e.g., producing a yield that meets a threshold amount). In some embodiments, the operation management component 210 can retrieve the data from the semi-agent 162D and provide it to analyst agent 162A with the instruction to perform the analysis identifying which pressure values satisfy the criteria. In other embodiments, upon receiving a notification from semi-agent 162D that it has completed the operation, the operation management component 210 can transmit an instruction to semi-agent 162D to transmit the data to analyst agent 162A, after which the operation management component 210 transmits the instruction to perform the analysis to analyst agent 162A.

In some embodiments, one or more agents 162 can access an external system (e.g., external system 170) to perform an operation. Depending on the embodiment, the external system can include a database (e.g., database 172) and/or an API (e.g., API 174). In some embodiments, the coordination agent 152 can identify an external database 172 and/or API 174 associated with an operation and include an indication of the identified database 172 and/or API 174 in the instruction to the agent. In other or similar embodiments, the coordination agent 152 can identify the data (e.g., provide a file address, a key, etc.) and/or specify a type of data (e.g., defect classification data, historical substrate measurements, etc.) associated with the operation to be retrieved from the identified database 172 and/or API 174 in the instruction to the agent. Based on the instruction, the agent 162 can retrieve the identified data from the database 172 and provide it to an AI model 190 to perform an operation and/or provide an input (e.g., an instruction to perform an operation and/or data corresponding to a manufacturing process) to the API 174 and obtain the output including data corresponding to an operation. For example, an instruction can include obtaining defect classification data associated with defects depicted in images of substrates from a specified process. If the defect classification data is stored in an external database 172, the instruction can include one or more data addresses associated with the data, which the associated knowledge query model can use to retrieve the requested data. Otherwise, the agent 162 can instruct the knowledge query model to retrieve the images of the substrates and provide the images to an external API 174 that will classify the defects in the images and output defect classification data.

In some embodiments, one or more additional AI models can be trained based on data received from external APIs 174. For example, in the above example an external API 174 is used to classify defects based on images of processed substrates. The received classification data and the images used as inputs to the API 174 can be stored in an internal database (e.g., data store 140 or memory 250) and used to train an AI model associated with an inspection subsystem. The images of processed substrates captured by an inspection station can be used as training inputs and the classification data received from the API 174 that corresponds to each image can be used as a training output. The training inputs and outputs can be used to train an AI model, which can be accessed and called by the coordination agent 152 to classify defects after being trained.

At block 308, processing logic determines whether the instructions have been transmitted to a respective computing device in the set of computing devices. In some embodiments, the operation management component 210 can include an indicator (e.g., a bit-level indicator and/or state variable, or higher-level abstraction to indicate a status of a condition or event) to indicate when an instruction to perform an operation has been transmitted to a computing device. For example, the operation management component 210 can transmit an instruction to a first agent to perform an operation and update the indicator to indicate that the instruction was transmitted (e.g., by changing the value of the bit and/or updating a variable indicating the transmittance of an instruction to a value indicating the instruction was transmitted). The operation management component 210 can determine that the instructions have been transmitted once the indicator for each operation indicates that the respective instruction was sent to a computing device. In other embodiments, the operation management component 210 can access an event log 256, or a record of actions (e.g., operations) taken by components in a system (e.g., coordination agent 152), to determine that each instruction was sent by verifying that a record of transmittance to a computing device is listed for each operation in the set of operations. In some embodiments, the event log 256 may be stored in memory 250 and/or a data store (e.g., data store 140). Upon a determination that the instruction was not transmitted, method 300 proceeds to block 304 to transmit the instructions.

Upon a determination that the instructions have been transmitted to the respective computing device, method 300 proceeds to block 310, where processing logic receives, from each computing device, data corresponding to an output of the respective AI model based on the transmitted instruction. In some embodiments, the coordination agent 152 can interact with (e.g., transmit instructions to and receive data from) every computing device an instruction was sent to. In other embodiments, the coordination agent 152 may receive data from computing devices with data that was not provided to another computing device to perform an operation (e.g., by determining which agents received an instruction to transmit data to another subsystem). For example, the coordination agent 152 can transmit an instruction to retrieve sensor data and metrology data from a process to a semi-agent 162D. The data retrieved by the semi-agent 162D is transmitted (e.g., by operation management component or semi-agent 162) to analyst agent 162A, which analyzes the sensor data to determine if there is a correlation between a process parameter (e.g., temperature) and the number of defects identified on a processed substrate. The coordination agent 152 can determine (e.g., by checking an event log 256 for a data transmission from one subsystem to another and/or maintaining an indicator for each subsystem indicating whether the data was transferred to another subsystem) that the semi-agent 162D transmitted the data to the analyst agent 162A for use in a separate operation and obtain only the output of the analyst agent 162A.

In some embodiments, the operation management component 210 can determine when each operation in the set of operations is completed. In some embodiments, the operation management component 210 can maintain an indicator (e.g., bit-level indicator or status variable) for each operation. Upon completing an operation, an agent can transmit a notice to the operation management component 210, which updates the indicator to a value indicating the operation is complete. In other embodiments, the agent can access the indicator to change the status and indicate that the operation is complete. In some embodiments, the operation management component 210 can access an event log 256 and determine whether the set of operations are complete by verifying if the completion of each operation is recorded in the log.

At block 312, processing logic generates a response to the user query based on the data received from each of the set of computing devices. In some embodiments, the response generation component 212 can summarize the data received from each agent 162 to generate the response. In some embodiments, the response generation component 212 can generate the response by selecting key sentences and/or phrases from the received data and combining the selected text to create a summary. In other embodiments, the response generation component 212 can generate new sentences to rephrase and summarize the received data. For example, if the task is to compare and analyze the average critical dimension uniformity (CDU) of a particular metrology job and compare it with the average CDU from historical metrology jobs, the response generation component 212 can receive data from one or more agents 162. The data can include a graph plotting the average CDU of each specific metrology job and information comparing the calculated averages. The response generation component 212 can identify significant data points (e.g., a ratio representing the difference between the average historical CDU and average CDU of the particular metrology job) by identifying sentences, phrases, and/or values in the data that correspond to the task. For example, the response generation component 212 can determine that a ratio representing the difference between the average CDUs is significant because the task requests a comparison and a ratio is a comparison of two values, which relates to the term comparison. The response generation component 212 can use the identified data points to generate a short summary of the data received from the computing devices and the generated graph.

In some embodiments, the response generation component 212 can generate responses based on previous interactions (e.g., a set of related user queries). The response generation component 212 can evaluate (e.g., identify patterns in) interactions, such as identifying specific queries that are asked together (e.g., queries that are included in the same request and/or in consecutive requests), to determine what information to include in a generated response. For example, the response generation component 212 can determine that user queries that include a task to determine the average CDU of more than one process are usually followed by a second user query to compare the average CDUs of the processes. As such, when the coordination agent 152 receives a task to generate the average CDU of two separate processes, the response generation component 212 can generate a response summarizing the average CDU of both processes and include a section in the response that compares the average CDUs and identifies the process with the better average CDU.

At block 314, processing logic provides the generated response to the user query to the client device (e.g., client device 120) in accordance with the user query. In some embodiments, the coordination agent 152 can transmit generated responses and/or reports to a client account (e.g., via electronic mail) based on the user request. Additionally, in some embodiments, the feedback control component 214 can receive feedback corresponding to the generated response from the client device 120. The feedback can include additional tasks to refine the response (e.g., a request to provide additional details or identify when incorrect (e.g., irrelevant) data has been provided) and/or update a response based on additional information (e.g., perform an analysis using new or additional data that was not included in the original request). In some embodiments, the feedback control component 214 can transmit an instruction to the response generation component 212 to generate a new response in accordance with the feedback (e.g., to add more detail in the generated response). In other or similar embodiments, the feedback control component 214 can generate a new task based on the feedback and provide the new task to the operation management component 210. The newly generated response can be provided to the client device 120 for presentation and/or further feedback.

FIG. 4 depicts a block diagram of a predictive system 110, in accordance with some embodiments of the present disclosure. In some embodiments, predictive system 110 includes server machine 470 and server machine 480. Server machine 470 includes a training set generator 472 that is capable of generating training data sets (e.g., a set of data inputs and a set of target outputs) to train, validate, and/or test one or more AI models 190. In some embodiments, the training set generator 472 can partition the training data into a training set, a validating set, and a testing set. In some embodiments, the predictive system 110 generates multiple sets of training data.

Server machine 480 includes a training engine 482, a validation engine 484, a selection engine 486, and/or a testing engine 488. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 482 can be capable of training an AI model 190. The AI model 190 can refer to the model artifact that is created by the training engine 482 using the training data that includes training inputs and corresponding target outputs (correct answers for respective training inputs). The training engine 482 can find patterns in the training data that map the training input to the target output (the answer to be predicted) and provide the patterns to the AI model 190 that captures these patterns. In some embodiments, the AI model 190 uses one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network, a recurrent neural network, a convolutional neural network, etc.), clustering techniques (e.g., hierarchical clustering techniques), association techniques (e.g., apriori techniques), classification techniques (e.g., decision trees, random forest techniques, etc.), a variational recurrent auto-encoder, etc. It should be noted that although some embodiments of the present disclosure describe model 190 as an AI model, such embodiments can be applied to any type of AI model, non-AI based model (e.g., a statistical model, a physical model, etc.), and/or a hybrid model (e.g., implementing AI techniques and non-AI techniques).

The validation engine 484 can be capable of validating a trained AI model 190 using a corresponding set of features of a validation set from training set generator 472. The validation engine 484 can determine an accuracy of each of the trained AI models 190 based on the corresponding sets of features of the validation set. The validation engine 484 can discard a trained AI model 190 that has an accuracy that does not meet a threshold accuracy. In some embodiments, the selection engine 486 can be capable of selecting a trained AI model 190 that has an accuracy that meets a threshold accuracy. In some embodiments, the selection engine 486 can be capable of selecting the trained AI model 190 that has the highest accuracy of the trained AI models 190.

The testing engine 488 can be capable of testing a trained AI model 190 using a corresponding set of features of a testing set from training set generator 472. For example, a first trained AI model 190 that was trained using a first set of features of the training set can be tested using the first set of features of the testing set. The testing engine 488 can determine a trained AI model 190 that has the highest accuracy of all of the trained AI models based on the testing sets.

Predictive server 412 includes a predictive component 112 that is capable of providing data as an input to a trained model 190 and obtaining one or more outputs of the trained model 190. As described herein, predictive component 112 can be a component of or otherwise associated with coordination agent 152 and/or agent(s) 162. In some embodiments, the predictive component 112 can provide an input (e.g., a prompt associated with a user query, an instruction to perform an operation, historical data, etc.) to a trained model 190 associated with coordination agent 152 and/or agents 162 and obtain the corresponding output of the AI model 190. For example, the predictive component 112 can provide a prompt associated with the user query to an AI model trained to generate a set of operations based on a prompt associated with a user query to perform one or more tasks. The predictive component 112 can obtain the output of the AI model, including the set of operations, and provide the output to coordination agent 152. In some embodiments, the predictive component 112 can determine whether an output of an AI model 190 satisfies one or more criteria before providing the output to the agent 162. For example, for a defect classification model, the predictive component 112 can determine whether the output confidence level corresponding to a classification for a defect on a substrate satisfies one or more confidence criteria (e.g., meets a threshold value) before providing the output to the agent 162.

It should be noted that in some other implementations, the functions of server machines 470 and 480, as well as predictive server 412, can be provided by a fewer number of machines. For example, in some embodiments, server machines 470 and 480 can be integrated into a single machine, while in some other or similar embodiments, server machines 470 and 480, as well as predictive server 412, can be integrated into a single machine.

In general, functions described in one implementation as being performed by server machine 470, server machine 480, and/or predictive server 412 can also be performed on client device 120. In addition, the functionality attributed to a particular component can be performed by different or multiple components operating together.

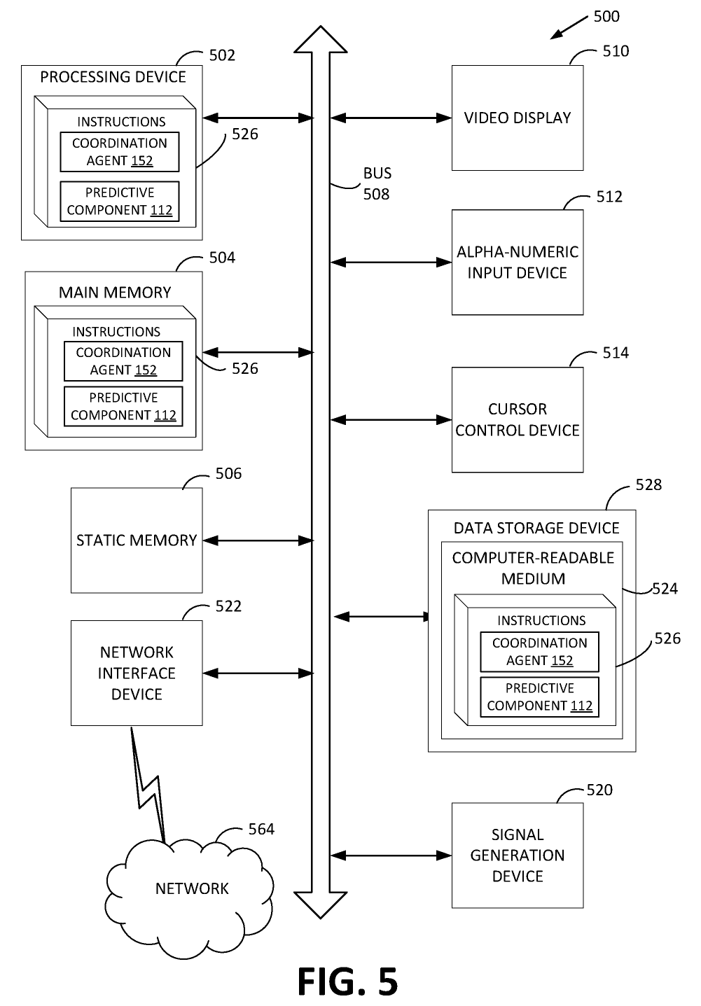

FIG. 5 depicts a block diagram of an illustrative computer system 500 operating in accordance with one or more aspects of the present disclosure. In alternative embodiments, the machine can be connected (e.g., networked) to other machines in a Local Area Network (LAN), an intranet, an extranet, or the Internet. The machine can operate in the capacity of a server or a client machine in a client-server network environment, or as a peer machine in a peer-to-peer (or distributed) network environment. The machine can be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 500 can correspond to predictive server 412 of FIG. 4 or another processing device of system 100 of FIG. 1. In other or similar embodiments, computing device 500 can correspond to computing system 150 of system 100.

The example computing device 500 includes a processing device 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 528), which communicate with each other via a bus 508.

Processing device 502 can represent one or more general-purpose processors such as a microprocessor, central processing unit, or the like. More particularly, the processing device 502 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. Processing device 502 can also be or include a system on a chip (SoC), programmable logic controller (PLC), or other type of processing device. Processing device 502 is configured to execute the processing logic for performing operations and steps discussed herein.

The computing device 500 can further include a network interface device 522 for communicating with a network 564. The computing device 500 also can include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 528 can include a machine-readable storage medium (or more specifically a non-transitory computer-readable storage medium) 524 on which is stored one or more sets of instructions 526 embodying any one or more of the methodologies or functions described herein. A non-transitory storage medium refers to a storage medium other than a carrier wave. The instructions 526 can also reside, completely or at least partially, within the main memory 504 and/or within the processing device 502 during execution thereof by the computer device 500, the main memory 504 and the processing device 502 also constituting computer-readable storage media.

The computer-readable storage medium 524 can also be used to store model 190 and data used to train model 190. The computer readable storage medium 524 can also store a software library containing methods that call model 190. While the computer-readable storage medium 524 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ± 10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
detecting, from a client device, a user query to perform a task pertaining to a manufacturing system associated with a plurality of specialized subsystems, wherein each of the plurality of specialized subsystems is associated with an aspect of a manufacturing process of the manufacturing system;
determining a plurality of operations associated with the task of the user query, wherein each of the plurality of operations are associated with a distinct artificial intelligence (AI) model;
transmitting, to each of a plurality of computing devices, an instruction to perform a respective operation of the plurality of operations associated with the task, wherein each of the plurality of computing devices is associated with a respective distinct AI model corresponding to an instructed respective operation and associated with a respective specialized subsystem of the plurality of specialized subsystems;
responsive to transmitting, to each of the plurality of computing devices, the instruction to perform the respective operation, receiving, from each of the plurality of computing devices, data corresponding to an output of the respective distinct AI model based on the instructed respective operation;
generating a response to the user query based on the data received from each of the plurality of computing devices, the response corresponding to the task pertaining to the manufacturing system; and
providing the generated response to the user query to the client device in accordance with the user query.

2. The method of claim 1, wherein the task comprises at least one of a trend analysis task, a design of experiment (DOE) task, an experiment analysis task, or one or more software-based engineering operations.

3. The method of claim 1, wherein determining a plurality of operations associated with the task of the user query further comprises:
providing the user query as an input to an AI model, wherein the AI model is trained to predict one or more operations associated with tasks of a given user query associated with the manufacturing system; and
obtaining one or more outputs of the AI model, wherein the one or more outputs comprise an indication of the plurality of operations.

4. The method of claim 1, wherein the distinct AI model comprises one of:
a knowledge query model, a coding model, a hardware control model, or an analysis model.

5. The method of claim 1, wherein the instruction to perform the respective operation of the plurality of operations associated with the task is transmitted to an AI agent associated with the respective distinct AI model, and wherein the data corresponding to the output of the respective distinct AI model is received from the AI agent.

6. The method of claim 1, further comprising:
identifying one or more of an external system or a database associated with the respective operation of the plurality of operations; and
transmitting with the instruction to perform the respective operation, at least one of:
an indication of the identified one or more of the external system or the database, or
additional data associated with the respective operation retrieved from the identified one or more of the external system or the database.

7. The method of claim 1, wherein the user query is a natural language query and wherein each distinct AI model is a respective large language model (LLM) trained to perform the corresponding respective operation associated with a specialized subsystem of the manufacturing system.

8. The method of claim 1, wherein the plurality of operations comprises at least one of obtaining historical data, generating code, generating a design of experiment, executing instructions for hardware, or analyzing experiments.

9. The method of claim 1, wherein the plurality of specialized subsystems comprises at least one of inspection systems, yield analysis systems, data collection systems, data analytics and feedback systems, research and development systems, process characterization systems, or simulation and modeling systems.

10. The method of claim 1, further comprising:
detecting, from the client device, an additional user query to perform an additional task based on the generated response, wherein the additional user query corresponds to the user query;
determining an additional plurality of operations associated with the additional task of the additional user query, wherein each of the additional plurality of operations are associated with an additional distinct AI model;
transmitting, to each of an additional plurality of computing devices, an additional instruction to perform an additional respective operation of the additional plurality of operations associated with the additional task, wherein each of the additional plurality of computing devices is associated with a respective additional distinct AI model corresponding to an additional instructed respective operation and associated with another respective specialized subsystem of the plurality of specialized subsystems;
responsive to transmitting, to each of the additional plurality of computing devices, the additional instruction to perform the additional respective operation, receiving, from each of the additional plurality of computing devices, additional data corresponding to an additional output of the respective additional distinct AI model based on the additional instructed respective operation;
generating an additional response to the additional user query based on the additional data received from each of the additional plurality of computing devices, wherein the generated additional response corresponds to an update in accordance with the additional user query; and
providing the generated additional response to the additional user query to the client device in accordance with the additional user query.

11. The method of claim 1, further comprising:
obtaining historical data associated with at least one of one or more historical user queries or one or more historical generated responses to perform tasks pertaining to the manufacturing system; and
determining a set of routine user queries based on the obtained historical data, wherein the detected user query corresponds to a routine user query of the set of routine user queries.

12. The method of claim 11, wherein the historical data further comprises information pertaining to a time period during which at least one of the one or more historical user queries were received from at least one of the client device or another client device or the one or more historical generated responses were generated, and wherein each of the set of routine user queries corresponds to a respective time period, and
wherein detecting the user query to perform the task pertaining to the manufacturing system comprises:
determining that a current time period corresponds to the time period associated with routine user query of the set of routine user queries.

13. A system comprising:
a memory; and
a set of one or more processing devices coupled to the memory, wherein the set of one or more processing devices is to:
detect, from a client device, a user query to perform a task pertaining to a manufacturing system associated with a plurality of specialized subsystems, wherein each of the plurality of specialized subsystems is associated with an aspect of a manufacturing process of the manufacturing system;
determine a plurality of operations associated with the task of the user query, wherein each of the plurality of operations are associated with a distinct artificial intelligence (AI) model;
transmit, to each of a plurality of computing devices, an instruction to perform a respective operation of the plurality of operations associated with the task, wherein each of the plurality of computing devices is associated with a respective distinct AI model corresponding to an instructed respective operation and associated with a respective specialized subsystem of the plurality of specialized subsystems;
responsive to transmitting, to each of the plurality of computing devices, the instruction to perform the respective operation, receive, from each of the plurality of computing devices, data corresponding to an output of the respective distinct AI model based on the instructed respective operation;
generate a response to the user query based on the data received from each of the plurality of computing devices, the response corresponding to the task pertaining to the manufacturing system; and
provide the generated response to the user query to the client device in accordance with the user query.

14. The system of claim 13, wherein the task comprises at least one of a trend analysis task, a design of experiment (DOE) task, an experiment analysis task, or one or more software-based engineering operations.

15. The system of claim 13, wherein determining a plurality of operations associated with the task of the user query further comprises:
providing the user query as an input to an AI model, wherein the AI model is trained to predict one or more operations associated with tasks of a given user query associated with the manufacturing system; and
obtaining one or more outputs of the AI model, wherein the one or more outputs comprise an indication of the plurality of operations.

16. The system of claim 13, wherein the instruction to perform the respective operation of the plurality of operations associated with the task is transmitted to an AI agent associated with the respective distinct AI model, and wherein the data corresponding to the output of the respective distinct AI model is received from the AI agent.

17. The system of claim 13, wherein the set of one or more processing devices coupled to the memory perform operations further comprising:
identifying one or more of an external system or a database associated with the respective operation of the plurality of operations; and
transmitting with the instruction to perform the respective operation, at least one of:
an indication of the identified one or more of the external system or the database, or
additional data associated with the respective operation retrieved from the identified one or more of the external system or the database.

18. The system of claim 13, wherein the plurality of operations comprises at least one of obtaining historical data, generating code, generating a design of experiment, executing instructions for hardware, or analyzing experiments.

19. A non-transitory computer readable medium comprising instructions that, when executed by a set of one or more processing devices, cause the set of one or more processing devices to:
determine, from a client device, a user query to perform a task pertaining to a manufacturing system associated with a plurality of specialized subsystems, wherein each of the plurality of specialized subsystems is associated with an aspect of a manufacturing process of the manufacturing system;
determine a plurality of operations associated with the task of the user query, wherein each of the plurality of operations are associated with a distinct artificial intelligence (AI) model;
transmit, to each of a plurality of computing devices, an instruction to perform a respective operation of the plurality of operations associated with the task, wherein each of the plurality of computing devices is associated with a respective distinct AI model corresponding to an instructed respective operation and associated with a respective specialized subsystem of the plurality of specialized subsystems;
responsive to transmitting, to each of the plurality of computing devices, the instruction to perform the respective operation, receive, from each of the plurality of computing devices, data corresponding to an output of the respective distinct AI model based on the instructed respective operation;
generate a response to the user query based on the data received from each of the plurality of computing devices, the response corresponding to the task pertaining to the manufacturing system; and
provide the generated response to the user query to the client device in accordance with the user query.

20. The non-transitory computer readable medium of claim 19, wherein determining a plurality of operations associated with the task of the user query further comprises:
providing the user query as an input to an AI model, wherein the AI model is trained to predict one or more operations associated with tasks of a given user query associated with the manufacturing system; and
obtaining one or more outputs of the AI model, wherein the one or more outputs comprise an indication of the plurality of operations.
